(19) United States
(12) Patent Application Publication
(10) Pub. No.: US 2015/0277741 A1
(43) Pub. Date: Oct. 1, 2015

(54) HIERARCHICAL VIRTUAL LIST CONTROL

(71) Applicant: Microsoft Corporation, Redmond, WA (US)

(72) Inventors: Jason V. Morse, Bellevue, WA (US); Andrew M. Coates, Lynnwood, WA (US); Endre Bognar, Bellevue, WA (US)

(73) Assignee: Microsoft Corporation, Redmond, WA (US)

(21) Appl. No.: 14/230,228

(22) Filed: Mar. 31, 2014

(51) Int. Cl. G06F 3/0485; G06F 3/0484

(52) U.S. Cl. CPC G06F 3/04855; G06F 3/04847; G06F 3/04842

(57) ABSTRACT

A scrollable container view renders hierarchically arranged layouts. Container items are only created and rendered to cover a view port on a user interface display screen, along with a buffer on each side of the view port. As the user pans or scrolls through the container, additional user interface items for the container are dynamically created and rendered.

### BACKGROUND

There are various different languages that are used to specify the visual presentation of underlying systems. For instance, HyperText Markup Language (HTML) is used for defining the visual presentation of a webpage. Extensible Application Markup Language (XAML) defines the visual presentation of various applications.

One fairly common user interface pattern is the display of a collection of data in a scrollable container. One example of a scrollable container is a list. Lists occur in a wide variety of different contexts. For instance, a list can occur in an electronic mail inbox where a user's messages are listed. It can also occur in a slide presentation program where a list of slides is provided, along with a slide sorter. Scrollable containers can also include navigation items in a navigation pane, and also font pickers and galleries in other applications.

Visual presentation languages can define the visual representation for controls, such as scrollable container (e.g., list) controls. Representing lists, using a list control, can be difficult. For instance, some lists are hierarchical in nature and thus have complicated layouts. A given item in a first list in a hierarchical layout, for example, can have another list embedded within it. Some current systems can only render these relatively complicated list layouts in a cumbersome way. That is, they often have the developer write a highly customized solution that is tailored to each given application.

Also, a user can often interact with a scrollable container. For instance, a scroll bar is often provided that allows the user to scroll through a list. In one embodiment, the scroll bar is sized to reflect the amount of data in the underlying list.

The discussion above is merely provided for general background information and is not intended to be used as an aid in determining the scope of the claimed subject matter.

### SUMMARY

A scrollable container viewer renders hierarchically arranged layouts. Container items are only created and rendered to cover a viewport on a user interface display screen, along with a buffer on each side of the viewport. As the user pans or scrolls through the container, additional user interface items for the container are dynamically created and rendered.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one exemplary virtual list viewing system.

FIG. 2 is a flow diagram illustrating one embodiment of the operation of the system shown in FIG. 1 in configuring a list control.

FIGS. 2A and 2B show exemplary layouts.

FIG. 3 shows one example of a hierarchical list.

FIG. 4 is a flow diagram illustrating one embodiment of how the system shown in FIG. 1 renders list layouts.

FIG. 4A shows one example of a user interface display.

FIG. 5 is a block diagram of one embodiment of the system shown in FIG. 1 deployed in a cloud computing architecture.

FIGS. 6-10 show various embodiments of mobile devices on which list controls can be rendered.

FIG. 11 is a block diagram of one illustrative computing environment.

### DETAILED DESCRIPTION

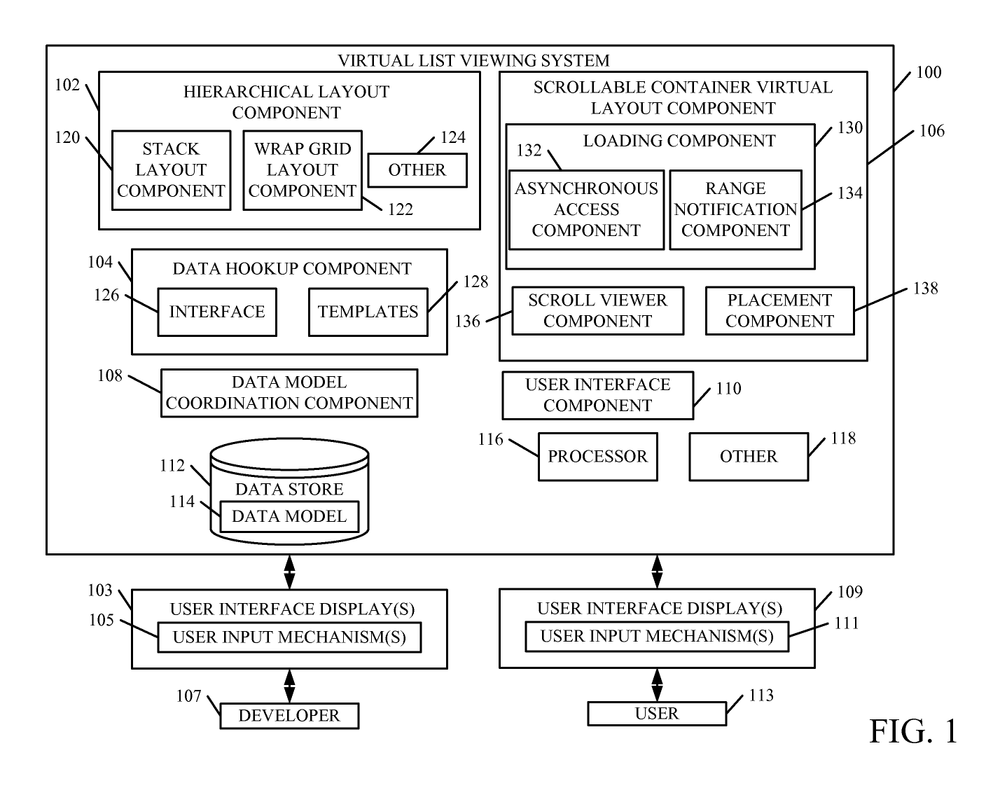

FIG. 1 is a block diagram of one embodiment of a virtual scrollable container viewing system 100. The present discussion will proceed with respect to the scrollable container being a list. It will be noted that it can be any other scrollable containers as well and a list is just one example.

FIG. 1 shows developer 107 interacting with system 100 through user input mechanisms 105 on user interface displays 103. FIG. 1 also shows user 113 interacting with system 100 through user input mechanisms 111 on user interface displays 109. Displays 103 and 109 can be generated by user interface component 110 either by itself or under control of other items in system 100. Also, developer 107 and user 113 can access system 100 directly, or through another device, over a network. As is described below, developer 107 generates a scrollable container control (e.g., a list control) that is used by user 113 in interacting with an application. While the components used by developer 107 and user 113 can also reside in separate systems (such as a developer environment and a runtime environment) they are described as part of system 100 for the sake of example only.

System 100 illustratively includes a hierarchical layout component 102, a data hookup component 104, a scrollable container virtual layout component 106, a data model coordination component 108, user interface component 110, data store 112 (which itself, includes data model 114), processor 116, and it can include other items 118 as well.

Hierarchical layout component 102 illustratively includes stack layout component 120, wrap grid layout component 122 and it can include other components 124 as well. Hierarchical layout component 102 illustratively allows a developer to generate a hierarchically arranged layout. In one embodiment, each level of the hierarchy in the scrollable container being developed can independently have its own layout specified using hierarchical layout component 102. All items below a single parent in the layout will share a common layout, but each child collection in the scrollable container can have a distinct layout. In one embodiment, stack layout component 120 can be used to generate a variable sized stack layout. Wrap grid layout component 122 can be used to generate a wrap grid layout. Each layout illustratively has a local scope in terms of indexing and positioning.

Data hookup component 104 illustratively has one or more interfaces 126 and one or more templates 128. Component 104 allows the developer to hook the scrollable container control being developed to a variety of different data types. Interface 126 is used to access data and perform data interactions with data model 114 in data store 112. Templates 128 can be provided between interface 126 and data model 114. In one embodiment, the data model 114 provides the scrollable container control a version of its interface (to data model 114), wrapped to automatically implement the interface 124 that the scrollable container control uses to communicate with data model 114.

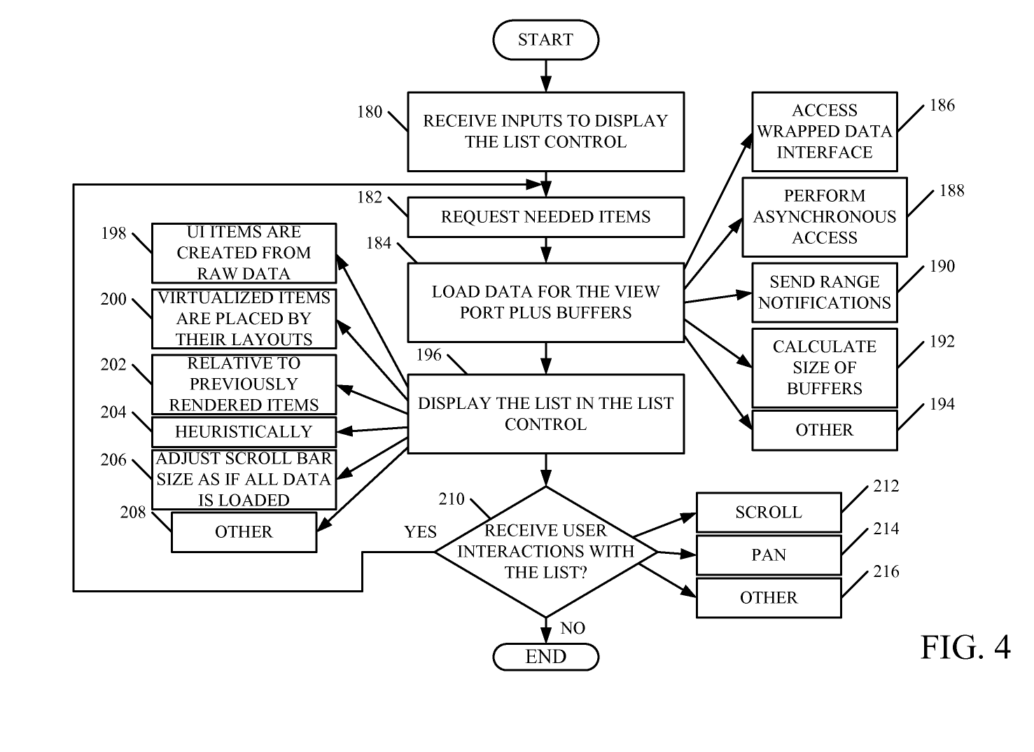

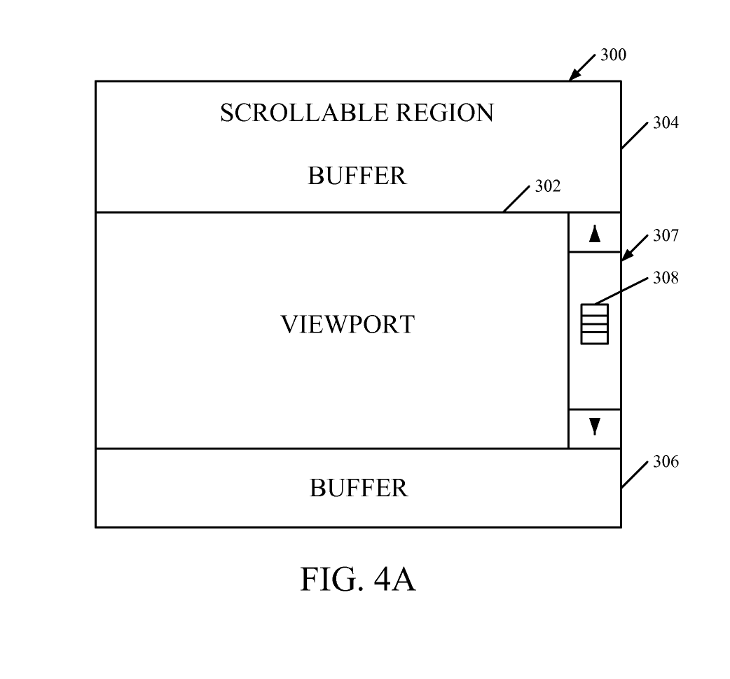

As is discussed in greater detail below with respect to FIG. 4, the interface 126 and templates 128 allow the scrollable container control to perform asynchronous access patterns which allow for items in an input collection to not immediately be created. Interface 126 and templates 128 also provide the ability for the scrollable container control to send range notifications to data model 114 to allow model 114 to know what data is to be loaded. Together, these items allow the scrollable container control to run against a data collection represented by data model 114, where only a subset of the total set of data is loaded at any given time into the control.

In one embodiment, data model coordination component 108 obtains raw data from data model 114, creates the user interface elements used to represent the raw data, and provides those elements to scrollable container virtual layout component 106. It illustratively coordinates communication between data model 114 and the virtual layout component 106.

Data model 114 illustratively supports index-based access. It can also illustratively support the asynchronous patterns mentioned above.

Scrollable container virtual layout component 106, in one embodiment, includes loading component 130 (which, itself, includes asynchronous access component 132 and range notification component 134). Virtual layout component 106 also illustratively includes scroll viewer component 136 and placement component 138. In one embodiment, loading component 130 loads items of data to support not only a viewport on the display device displaying the list control, but also a buffer on either or both sides of the viewport. The viewport is a part of the scrollable list control that is visible to the user. This provides a user interface virtualization where only the user interface elements that are visible to the user (and displayed in the viewport), plus the buffer portions, are actually created. This can appear no different than a standard user interface, but can take significantly less time to load and consume less computing and memory overhead.

The size of the buffers for which data is loaded can be determined using heuristics based upon a combination of average item sizes in the list and user settings. If no rendered items are available, then the heuristics can accommodate this as well, and obtain a default buffer size, or a calculated buffer size that is calculated in other ways.

Asynchronous access component 132 illustratively accesses data from data model 114 using data virtualization. This allows component 132 to deal with relatively large data sets, where only a subset of the data is loaded at any given time. For instance, this type of data virtualization can be used in large scale scenarios, such as when loading a mail list which may include thousands of entries.

Range notification component 134 illustratively performs pre-fetching. It illustratively predicts a range of user interface elements that are going to be queried, based upon the currently displayed viewport. This prediction can be provided to data model 114 (or a cache in data model 114) to enable loading component 106 to begin data fetching before the data is actually needed for display within the viewport. This also allows loading component 130 to request data in blocks, rather than item by item. Range notification component 134 also accounts for the fact that certain data items go out of view on the viewport as the user scrolls. It updates the range of data that loading component 130 is interested in, and notifies data model 114 of this update.

Scroll viewer component 136 illustratively presents a scroll bar with a thumb (or other scroll control) that allows a user to scroll through the list or other scrollable container. Scroll viewer component 136 illustratively sizes the thumb on the scroll bar to provide an indication as to the size of the underlying list. Thus, the thumb is sized as if all items in the list were loaded into the control. Scroll viewer component 136 indicates to load component 130 when the user is scrolling the scrollable container, so that additional items can be loaded, on demand, as the user scrolls.

Placement component 138 illustratively indicates where elements within the scrollable container are to be placed on the display screen. Each layout illustratively assumes it is beginning at coordinate 0,0, but it is being rendered relative to other rendered items in the viewport.

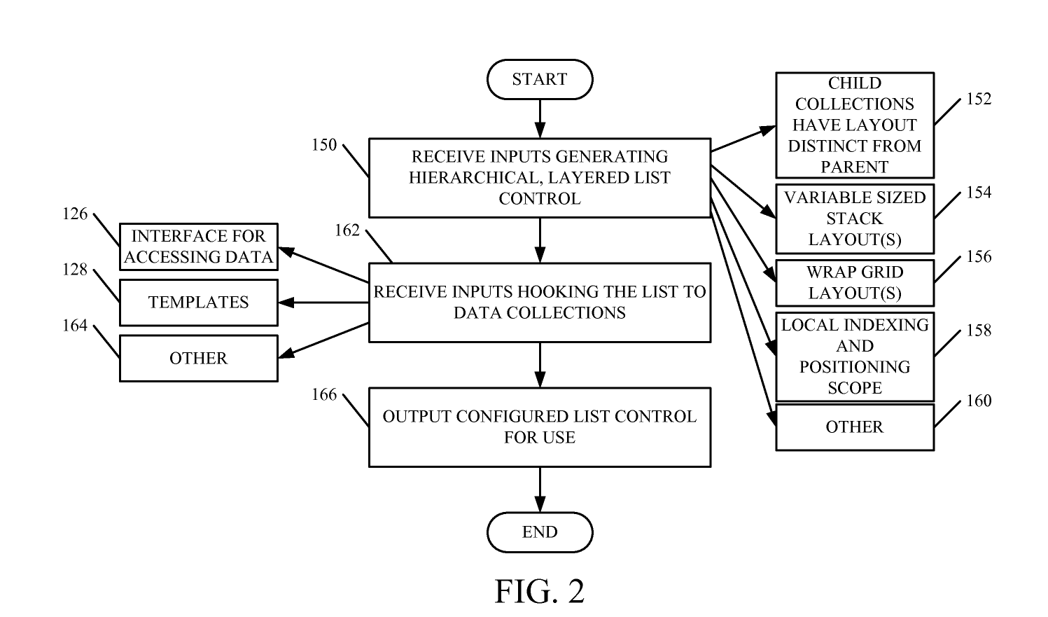

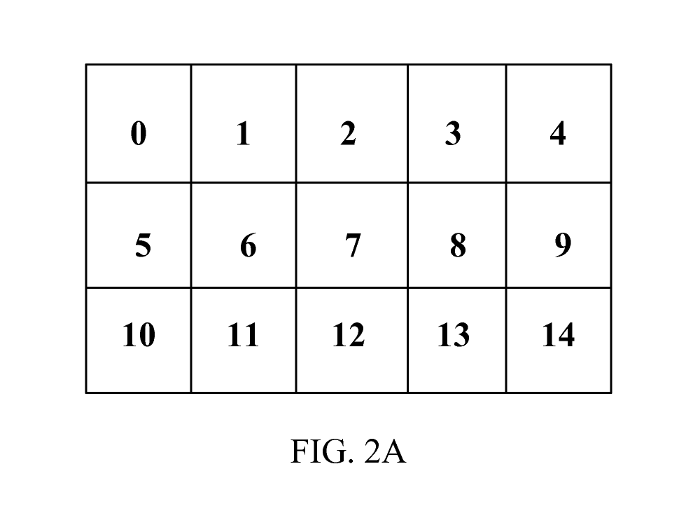

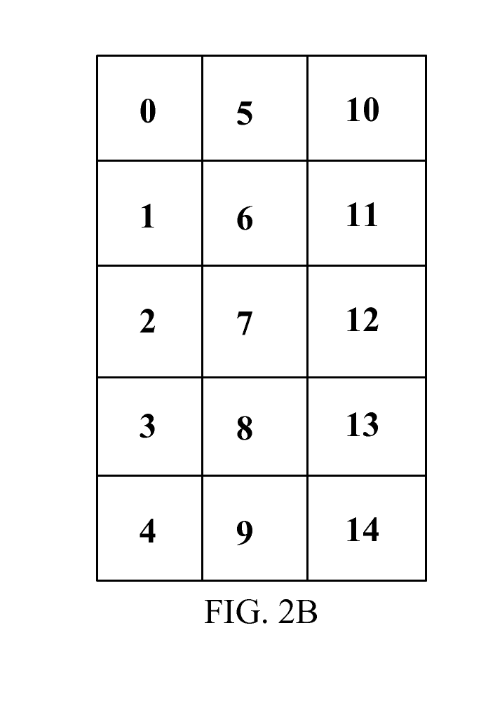

FIG. 2 is a flow diagram illustrating one embodiment of the system shown in FIG. 1 in allowing a developer to generate a hierarchical, virtual scrollable container. Hierarchical layout component 102 first receives developer inputs generating a hierarchical, layered list control. This is indicated by block 150 in FIG. 2. In one embodiment, the child collections in the layered list control can have layouts that are distinct from the layouts for the parents in the list. This is indicated by block 152. The layouts can, for example, include a variable sized stack layout 154. In one embodiment, this layout is a layout in which all items are positioned in a line either horizontally or vertically. Items within the stack can have variable sizes, and the size can change dynamically.

In another embodiment, the layouts can include a wrap grid layout 156. This is a layout in which all items can be the same size and arranged in a grid according to the space available. It can, for example, implement a tiled layout where like-sized items are arranged in lines along an off-axis of movement. For instance, if the layout is a vertical layout, then items can be arranged as shown in FIG. 2A. If it is a horizontal arrangement, they can be arranged as shown in FIG. 2B. These are exemplary layouts only.

In any case, each of the layouts in the hierarchical layered list control has local indexing and positioning scope. This is indicated by block 158 of FIG. 2. That is, they are each laid out within their corresponding visual area, as if they were being laid out at coordinates 0, 0, on the overall display. Inputs generating a hierarchical, layered list control can indicate other items as well, and this is indicated by block 160.

Data hookup component 104 then receives inputs from the developer 107 that hook the data collections modeled by data model 114 to the list control. This is indicated by block 162. As discussed above, component 104 can illustratively use interface 126 for accessing the data, along with templates 128. Of course, other items 164 can be used as well.

Once the developer 107 has configured the list control and hooked it to data collections, it is illustratively output for use. This is indicated by block 166 in FIG. 2.

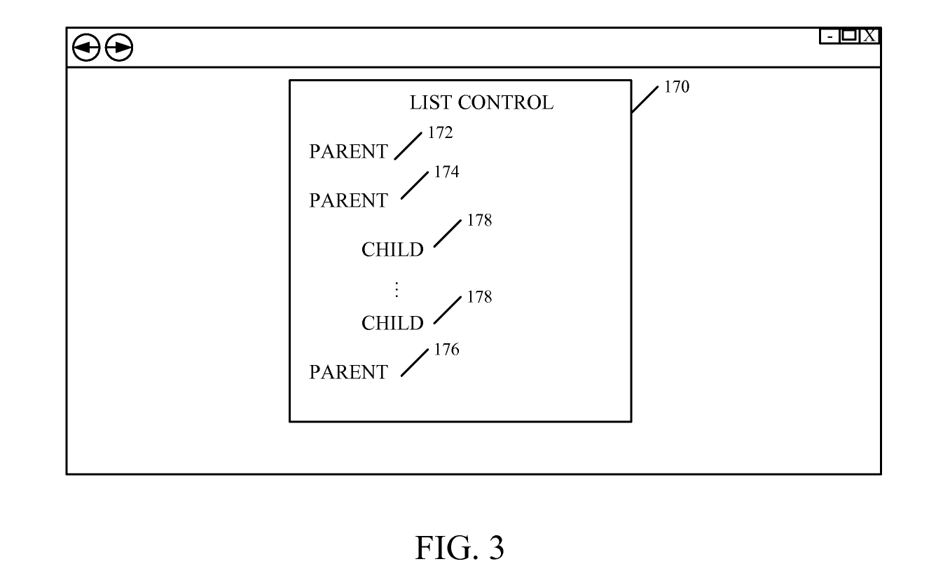

FIG. 3 shows a simplified embodiment of a configured list control 170. List control 170 has a plurality of parent items 172, 174 and 176. Parent item 174 is also shown with a plurality of different child items 178. It will be noted that the parent items 172, 174 and 176 will share a common layout. However, in one embodiment, the child items 178 can have their own, independent and distinct layouts, that are distinct from the parent layout.

FIG. 4 is a flow diagram illustrating one embodiment of how the control for the scrollable container can be used by user 113, once it is configured by the developer 107. In one embodiment, the system that is using the scrollable container control receives user inputs indicating that the user 113 wishes to have the control displayed. This is indicated by block 180 in FIG. 4.

By way of example, the user 113 may access his or her mailbox where a scrollable list control is implemented. In another embodiment, the user 113 may be accessing a slide presentation application, where the slides are listed in a list view where the scrollable list control is implemented. In yet another embodiment, the user 113 may be accessing an application that has a navigation pane that lists navigation links or other navigation user input mechanisms. Of course, there are a wide variety of other scenarios in which a user can provide inputs indicating that the user wishes to view content represented by the scrollable container control.

In response, loading component 130 illustratively requests needed items from data model 114. This is indicated by block 182 in FIG. 4. Again, the needed items requested will be those that are used to populate the viewport, along with a buffer on either or both sides of the viewport. This is indicated by block 184 in FIG. 4.

FIG. 4A shows one embodiment of an exemplary user interface display 300. Display 300 includes a viewport 302 which is the visual area on the display screen. Scrollable region 300 also includes a first buffer 304 and a second buffer 306. Buffers 304 and 306 hold data that is loaded so that, if the user moves the scroll bar 307, the data displayed in viewport 302 can be quickly and smoothly displayed for the user. It will also be noted that, in one embodiment, the thumb 308 of scroll bar 307 is sized to reflect the size of the underlying list. For instance, if the underlying list is large, then thumb 308 is made small to indicate that the portion of the list being viewed in viewport 302 is a small part of the overall list.

In loading data to display the control, load component 130 can illustratively access the wrapped data interface exposed by data model 114. This is indicated by block 186. It can perform asynchronous access, as indicated by block 188. It can send range notifications as indicated by block 190, and it can also perform a calculation of the size of the buffer portions 304 and 306 on either side of the viewport 302 for which data is to be loaded. This is indicated by block 192. It can perform other operations as well. This is indicated by block 194.

Component 106 then displays the list within the list control. This is indicated by block 196. In one embodiment, user interface items are created from the raw data retrieved from model 114. This can be performed by data model coordination component 108 in system 100, or by another component. This is indicated by block 198 in FIG. 4.

Placement component 138 then identifies where each of the virtualized items are to be placed on the display screen, by their corresponding layouts. This is indicated by block 200. In one embodiment, they are placed relative to previously rendered items as indicated by block 202, and they can also be placed heuristically as indicated by block 204.

Scroll viewer component 136 then adjusts the size of a thumb or other scroll element on any scroll bar that is displayed as if all of the data in the underlying list were loaded. This is indicated by block 206. The list can be displayed in other ways as well, and this is indicated by block 208.

Where the list control includes a wrap grip layout, a number of items are considered. For instance, the size of the various user interface items is considered. This can be provided as a configuration parameter or it can be obtained by measuring the size of the first item retrieved from the data model. The size of the viewport 302 is also considered. This is used to determine how many items are arrange per row, and to determine which sections of the data collection are to be resized. A direction of any scroll input is also considered. This can be used in the case of a child layout to determine whether to begin creating and rendering items from the end of the child list item or from the beginning. For instance, if the user is panning backward into the end of a preceding data collection on the display, then the last items in the child collection are created and rendered first. If the user is panning in the other direction, the first items are created and rendered first. The number of items in the data collection being rendered can also be considered. It can be obtained through a suitable programming interface input, and it can be used to calculate the total size of the layout. Also, the user interface element for the item to be displayed or inserted into the collection can be used. In one embodiment, a minimum number of items that are needed to meet or exceed the bounds of the viewport 302 are created and arranged, as appropriate. The minimum number of items can be calculated based on a fixed size (obtained from the first item retrieved) or from a variable size that is measured per item.

If the layout is a virtual stack layout, such a layout can provide a stack panel that is either vertical or horizontal, with heterogeneous item sizes that enables child collections of any arbitrary layout. The virtual stack layout will include some of the same considerations that the wrap grid layout considers, as are discussed above. If child layouts are also used, then virtual layout component 106 will also consider whether the particular element being displayed has an expanded child collection. It will then create an appropriate layout to represent the elements within the collection, including their children. This allows the plugging of custom layouts at arbitrary levels into the layout system.

For a virtual stack layout, load component 130 can use a cache. If it does, it can continue loading data into the cache until the size of the realized area covers the viewport 302. When an item has a child collection, the parent item is realized and the layout for the child is also obtained. The size of the child layout can be used to determine whether sufficient data has been loaded to cover the viewport 302.

Once the scrollable container control is displayed, it may receive user interaction. This is indicated by block 210 in FIG. 4. For instance, where the container is a list control, the user may provide a scroll input 212 to scroll through the list. The user may also provide a pan input 214 to cause the display to pan, or the user can provide other inputs 216. If so, processing reverts to block 182 where load component 130 requests data to be loaded for the viewport 302 and buffers 304 and 306.

As the user scrolls using scroll bar 307, load component 130 continuously revises the data loaded into the buffers 304 and 306.

It can thus be seen that the list view described herein provides unbounded layout flexibility in that layouts can be layered and combined as desired. Also, the user interface is virtualized so that, even across hierarchical layouts and large lists, the only user interface items that are created and rendered are those that are used to cover the viewport 302, with some padding or buffering 304 and 306 on each side. As the user pans or scrolls the control, the user interface items are created dynamically. This allows for fast loading and consistent pan and scroll speeds. Further, data is connected using data virtualization. This allows the control to support many different types of collections, and allows for collection forms where only a subset (such as a superset of the visible range) of the collection data is actually in a given collection.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

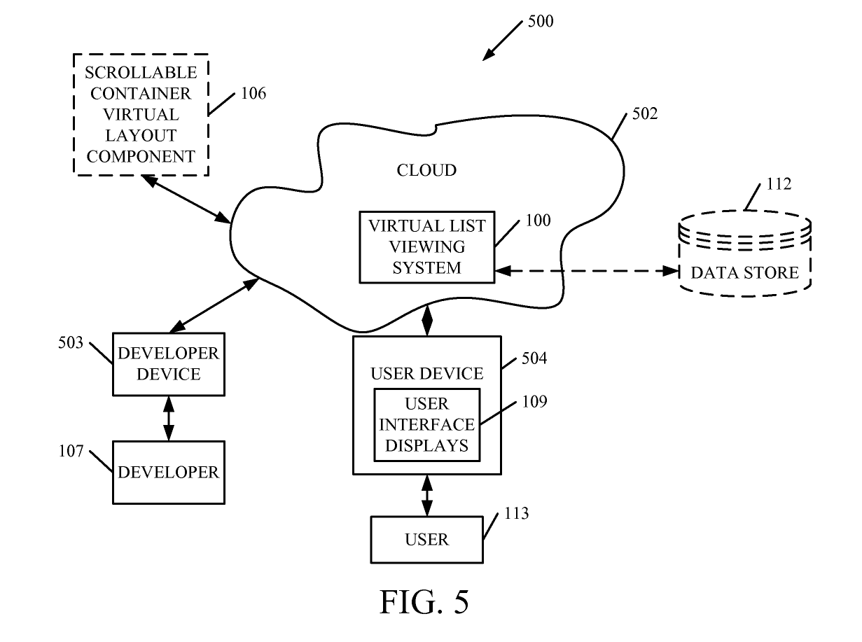

FIG. 5 is a block diagram of system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that system 100 is located in cloud 502 (which can be public, private, or a combination where portions are public while others are private). Therefore, developer 107 and user 113 use a developer device 503 and a user device 504 to access the system through cloud 502.

FIG. 5 also depicts another embodiment of a cloud architecture. FIG. 5 shows that it is also contemplated that some elements of system 100 can be disposed in cloud 502 while others are not. By way of example, data store 114 can be disposed outside of cloud 502, and accessed through cloud 502. In another embodiment, scrollable container virtual layout component 106 can also be outside of cloud 502. Regardless of where they are located, they can be accessed directly by devices 503 and 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

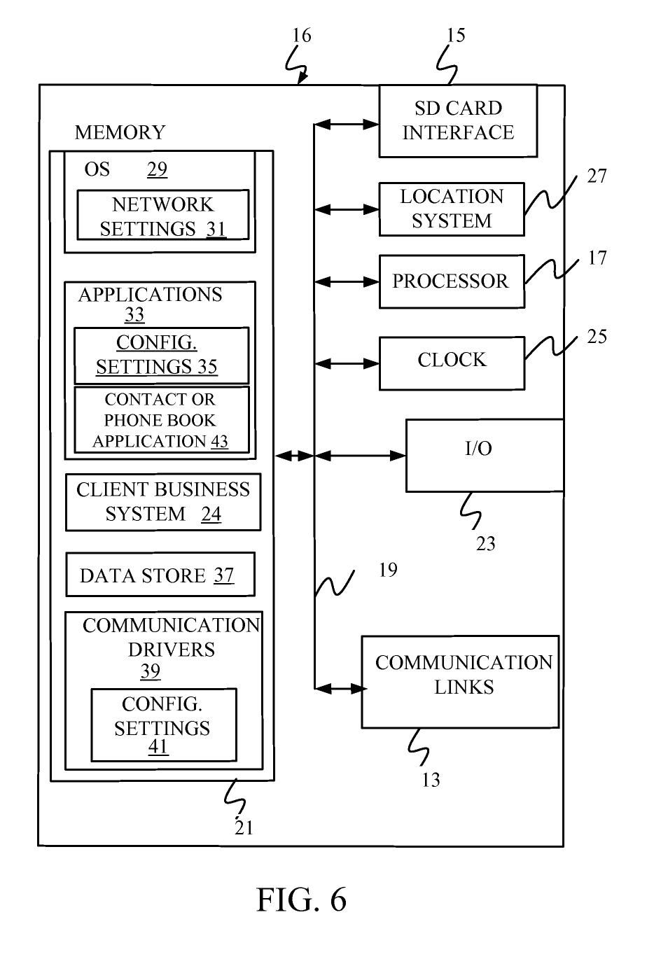

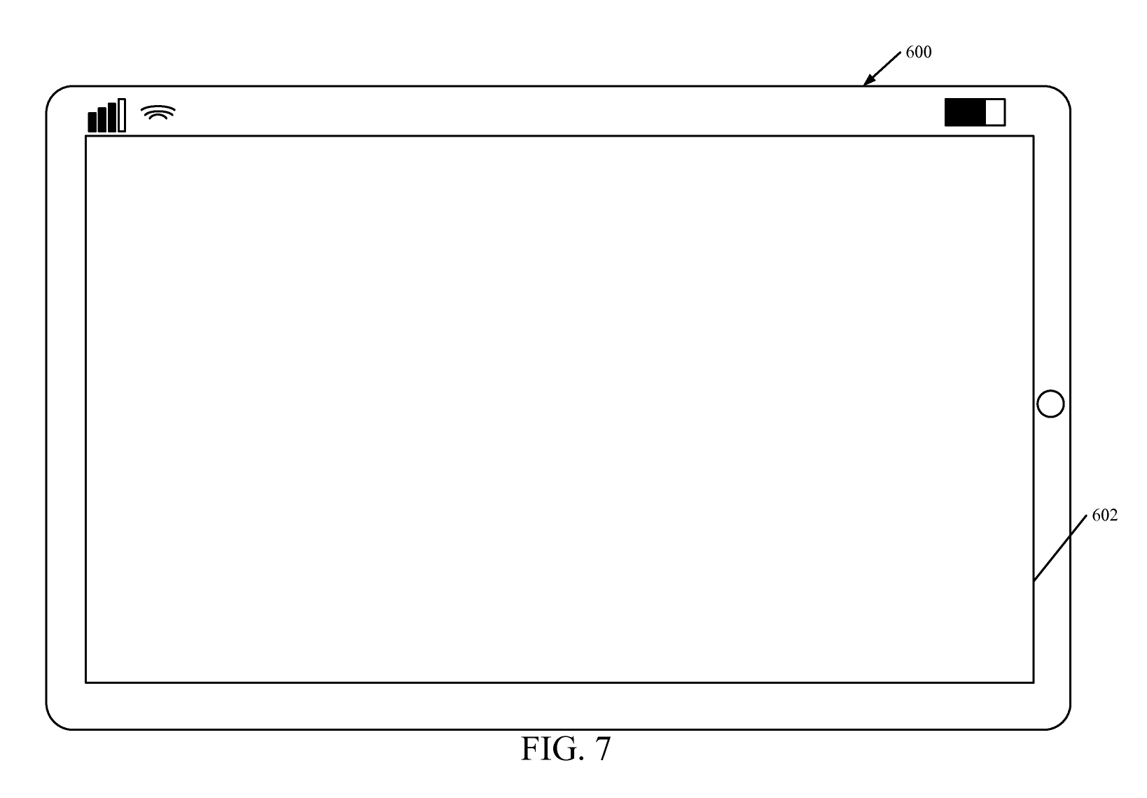

FIG. 6 is a simplified block diagram of one illustrative embodiment of a handheld or mobile computing device that can be used as a user's or client's hand held device 16, in which the present system (or parts of it) can be deployed. For instance, the scrollable container can be used on device 116. FIGS. 7-10 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 116 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application such as the scrollable container) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

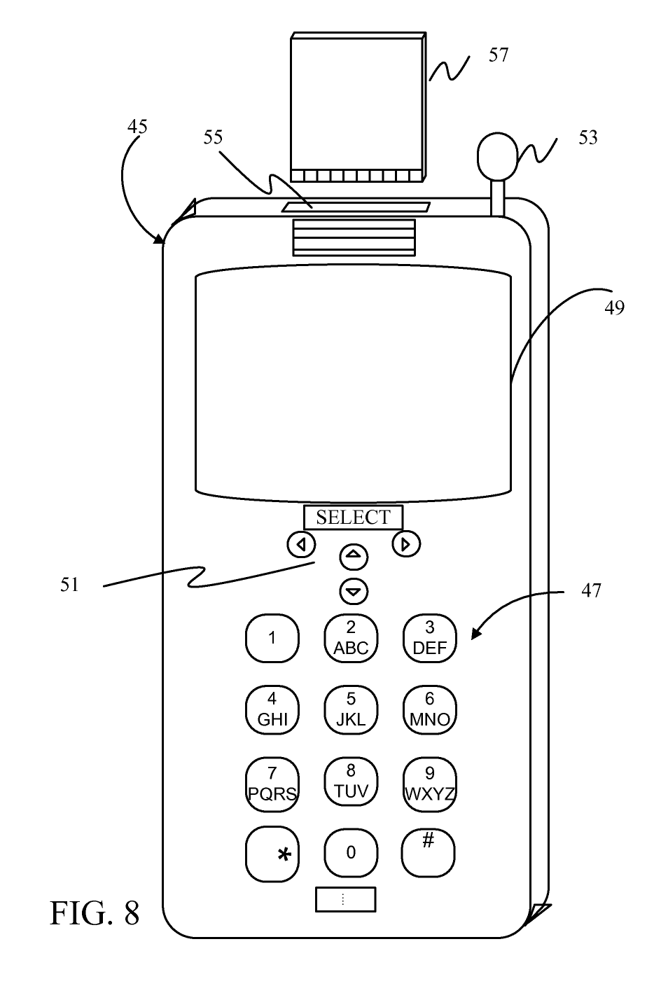

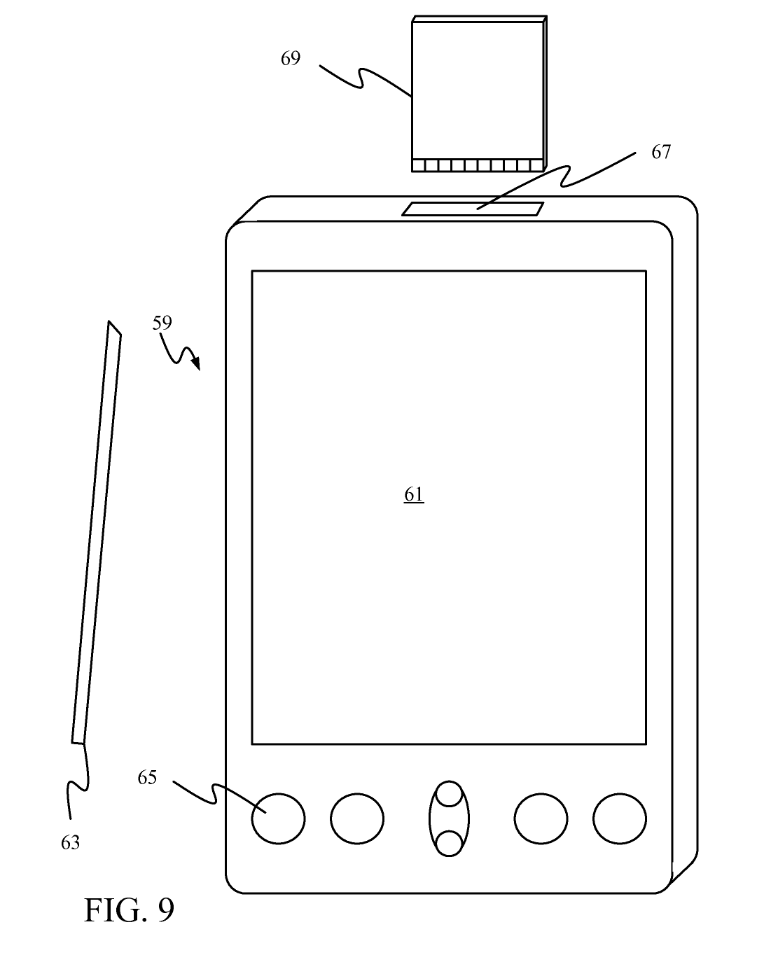

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

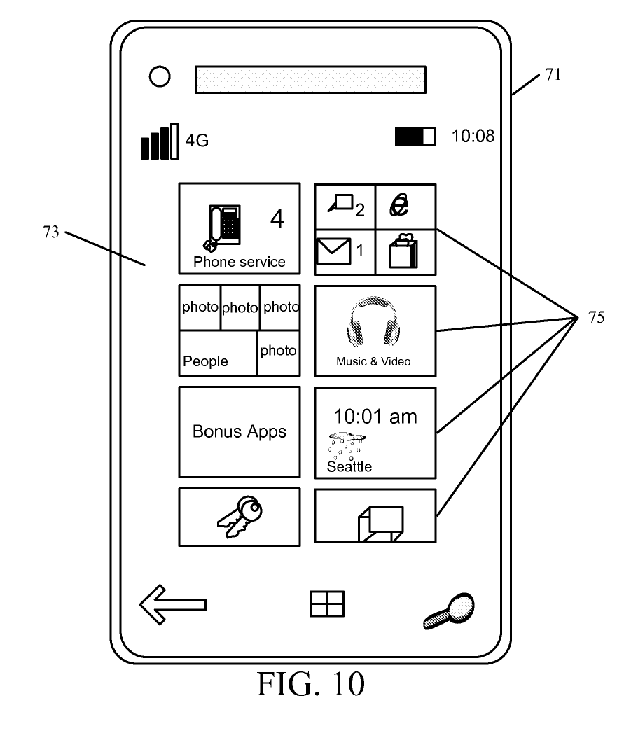

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

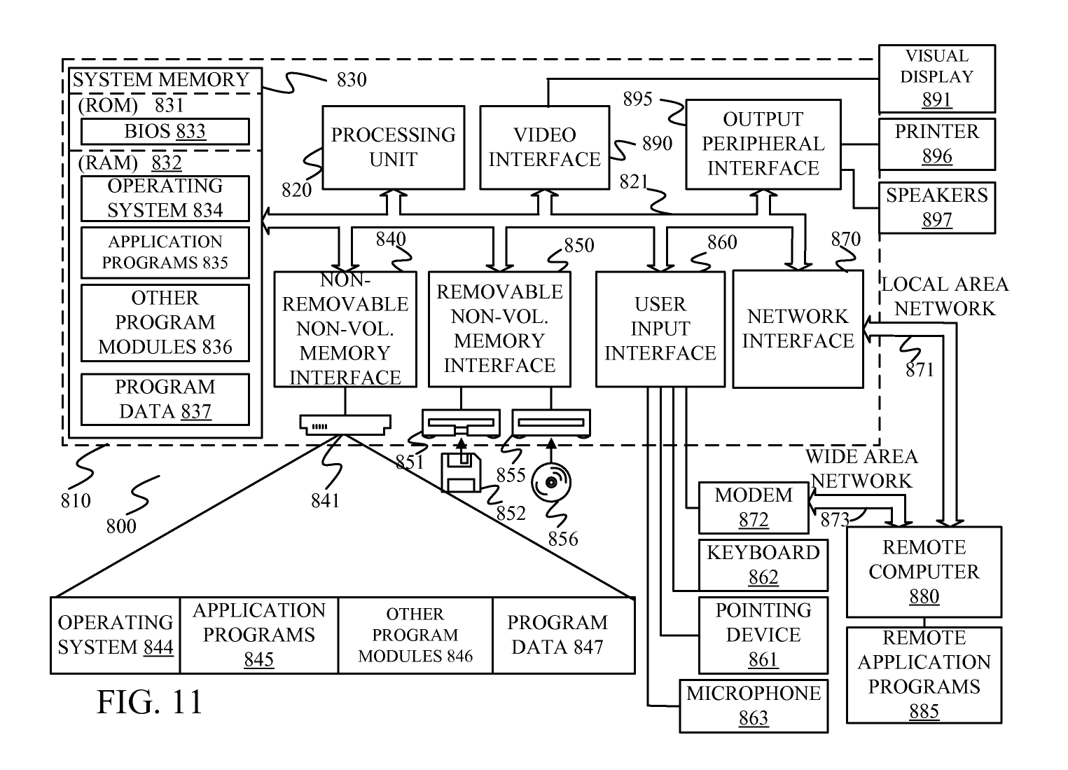

FIG. 11 is one embodiment of a computing environment in which system 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 116), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving a user input to display a scrollable container in a scrollable container control;
loading, into the scrollable container control, a first subset of data corresponding to the scrollable container defined by the scrollable container control, the first subset of data corresponding to a set of display elements sufficient to fill a viewport on a display device displaying the scrollable container; and
displaying the first subset of data in the scrollable container control.

2. The computer-implemented method of claim 1 wherein displaying comprises:
displaying the set of display elements corresponding to the first subset of data according to a layout.

3. The computer-implemented method of claim 2 wherein loading the first subset of data into the scrollable container control comprises:
loading the first subset of data into a hierarchical control having a plurality of different hierarchical levels.

4. The computer-implemented method of claim 3 wherein displaying the set of display elements according to a layout comprises:
creating a first portion of the set of display elements from data obtained from a data model; and
displaying the first portion of the set of display elements according to a first layout corresponding to a first level of the plurality of different hierarchical levels.

5. The computer-implemented method of claim 4 wherein displaying the set of display elements according to a layout comprises:
creating a second portion of the set of display elements; and
displaying the second portion of the set of display elements according to a second layout, that is different from the first layout, corresponding to a second level of the plurality of different hierarchical levels.

6. The computer-implemented method of claim 5 wherein displaying the second portion of the set of display elements comprises:
positioning the second portion of the set of display elements in the viewport relative to a position of the displayed first portion of the set of display elements.

7. The computer-implemented method of claim 6 wherein displaying the first subset of data comprises:
displaying a scroll user input mechanism sized based on an overall size of the set of data corresponding to the scrollable container.

8. The computer-implemented method of claim 7 wherein displaying a scroll user input mechanism comprises:
displaying a scroll bar with a thumb sized based on the overall size of the set of data corresponding to the scrollable container.

9. The computer-implemented method of claim 7 and further comprising:
receiving a scroll user input through the scroll user input mechanism; and
loading an additional set of data into the scrollable container control based on a magnitude of the scroll input.

10. The computer-implemented method of claim 2 and further comprising:
loading a second subset of data corresponding to a set of display elements sufficient to fill a first buffer display area adjacent the viewport, on a first side of the viewport in the scrollable container control.

11. The computer-implemented method of claim 10 and further comprising:
calculating a size of the first buffer based on a size of already-loaded display elements.

12. The computer-implemented method of claim 2 and further comprising:
loading a third subset of data corresponding to a set of display elements sufficient to fill a second buffer display area adjacent the viewport, on a second side of the viewport in the scrollable container control.

13. The computer-implemented method of claim 12 and further comprising:
calculating a size of the second buffer based on a size of already-loaded display elements.

14. A computer system, comprising:
a scroll viewer component that receives a user input to display a scrollable container in a scrollable container control;
a loading component that loads, into the scrollable container control, a first subset of data corresponding to the scrollable container defined by the scrollable container control, the first subset of data corresponding to a set of display elements sufficient to fill a viewport on a display device displaying the scrollable container;
a user interface component that displays the first subset of data in the scrollable container control; and
a computer processor that is functional part of the system and is activated by the scroll viewer component, the loading component and the user interface component to facilitate receiving the user input, loading and displaying.

15. The computer system of claim 14 and further comprising:
a hierarchical layout component that generates a first layout in a hierarchical scrollable container control at a first hierarchical level and a second layout at a second hierarchical level in the hierarchical scrollable container.

16. The computer system of claim 15 and further comprising:
a data hookup component that receives a user input that couples data from a data model to the scrollable container.

17. The computer system of claim 15 and further comprising:
a data model coordination component that receives data requests from the scrollable container control and obtains data from the data model.

18. A computer readable storage medium that stores computer executable instructions which, when executed by a computer, cause the computer to perform a method, comprising:
receiving a user input to display a hierarchical scrollable container in a hierarchical scrollable container control;
loading, into the hierarchical scrollable container control, a first subset of data corresponding to the hierarchical scrollable container defined by the hierarchical scrollable container control, the first subset of data corresponding to a set of display elements sufficient to fill a viewport on a display device displaying the hierarchical scrollable container; and
displaying the first portion of the set of display elements according to a first layout corresponding to a first level of a plurality of different hierarchical levels in the hierarchical scrollable container; and
displaying a second portion of the set of display elements according to a second layout, that is different from the first layout, corresponding to a second level of the plurality of different hierarchical levels.

19. The computer readable storage medium of claim 18 and further comprising:
displaying a scroll user input mechanism sized based on an overall size of the set of data corresponding to the scrollable container.

20. The computer readable storage medium of claim 19 and further comprising:
loading a second subset of data corresponding to a set of display elements sufficient to fill a first buffer display area adjacent the viewport, on a first side of the viewport in the scrollable container control; and
loading a third subset of data corresponding to a set of display elements sufficient to fill a second buffer display area adjacent the viewport, on a second side of the viewport in the scrollable container control.
